(19) United States
(12) Patent Application Publication
(10) Pub. No.: US 2025/0208621 A1
(43) Pub. Date: Jun. 26, 2025

(54) REMOTE DRIVING SYSTEM

(71) Applicant: TOYOTA JIDOSHA KABUSHIKI KAISHA, Toyota-shi (JP)

(72) Inventors: Yuki SUEHIRO, Susono-shi (JP); Shuichi TAMAGAWA, Kitanagoya-shi (JP)

(73) Assignee: TOYOTA JIDOSHA KABUSHIKI KAISHA, Toyota-shi (JP)

(21) Appl. No.: 18/890,772

(22) Filed: Sep. 20, 2024

(30) Foreign Application Priority Data
Dec. 21, 2023 (JP) 2023-215807

(51) Int. Cl. G05D 1/227

(52) U.S. Cl. CPC G05D 1/2279

(57) ABSTRACT

The remote driving system comprises one or more processors configured to additionally assign, at predetermined conditions, a second remote driver to a target mobility to which the first remote driver is assigned. The target mobility is configured to operate according to the driving operation information of the remote driving by the first remote driver while the remote driving by the second remote driver is not being performed, and to operate according to the driving operation information of the remote driving by the second remote driver while the remote driving by the second remote driver is being performed.

### CROSS-REFERENCE TO RELATED APPLICATION

This application claims priority to Japanese Patent Application No. 2023-215807 filed on Dec. 21, 2023, incorporated herein by reference in its entirety.

### BACKGROUND

### 1. Technical Field

The present disclosure relates to a remote driving system for remote driving of a mobility.

### 2. Description of Related Art

WO2020/249305 discloses a method for operating a remotely operated vehicle. In the method disclosed in WO2020/249305, the remotely operated vehicle is connected to a first control center and a second control center. In normal operation, the remotely operated vehicle is operated by an operator of the first control center by communication with the first control center. The communication path between the second control center and the remotely operated vehicle is in a standby state in which the communication path can be switched from that for the first control center.

### SUMMARY

In the remote driving system, a remote driver is assigned to a mobility, and remote driving of the mobility is performed by the assigned remote driver. Typically, one remote driver is assigned to one mobility. The assigned remote driver makes driving determination in the remote driving of the mobility. One assigned remote driver may make erroneous driving determination. Prediction of such a situation is a problem in the safety of the remote driving of the mobility.

The technology disclosed in WO2020/249305 realizes a redundant remote driving system in which the first control center and the second control center are connected to one mobility, and the availability of the system can be improved. The second control center is in the standby state, and the driving determination made by the remote driver (operator) of the second control center is not reflected in the remote driving of the mobility in the normal operation. Thus, the above problem has not been studied sufficiently.

One aspect of the present disclosure relates to a remote driving system in which a remote driver is assigned to a mobility and remote driving of the mobility is performed by the assigned remote driver. The remote driving system includes one or more processors configured to additionally assign, under a predetermined condition, a second remote driver to a target mobility to which a first remote driver is assigned.

The target mobility is configured to operate based on first driving operation information on the remote driving by the first remote driver while the remote driving by the second remote driver is not being performed, and to operate based on second driving operation information on the remote driving by the second remote driver while the remote driving by the second remote driver is being performed.

According to the present disclosure, it is possible to realize the remote driving of the mobility by cooperation of the first remote driver and the second remote driver. Accordingly, it is possible to appropriately secure the safety of the remote driving of the mobility.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram for describing an overall configuration of a remote driving system according to an embodiment;

FIG. 2 is a block diagram illustrating an example of a configuration of a remote driving system related to remote driving by a remote driver;

FIG. 3 is a conceptual diagram for explaining remote driving of mobility by cooperation of a first remote driver and a second remote driver in the remote driving system according to the embodiment;

FIG. 4 is a conceptual diagram for explaining a switching time from remote driving by the first remote driver to remote driving by the second remote driver; and

FIG. 5 is a diagram illustrating a processing flow executed in the remote driving system according to the embodiment.

### DETAILED DESCRIPTION OF EMBODIMENTS

Embodiments of the present disclosure will be described with reference to the accompanying drawings.

### 1 Remote Driving System

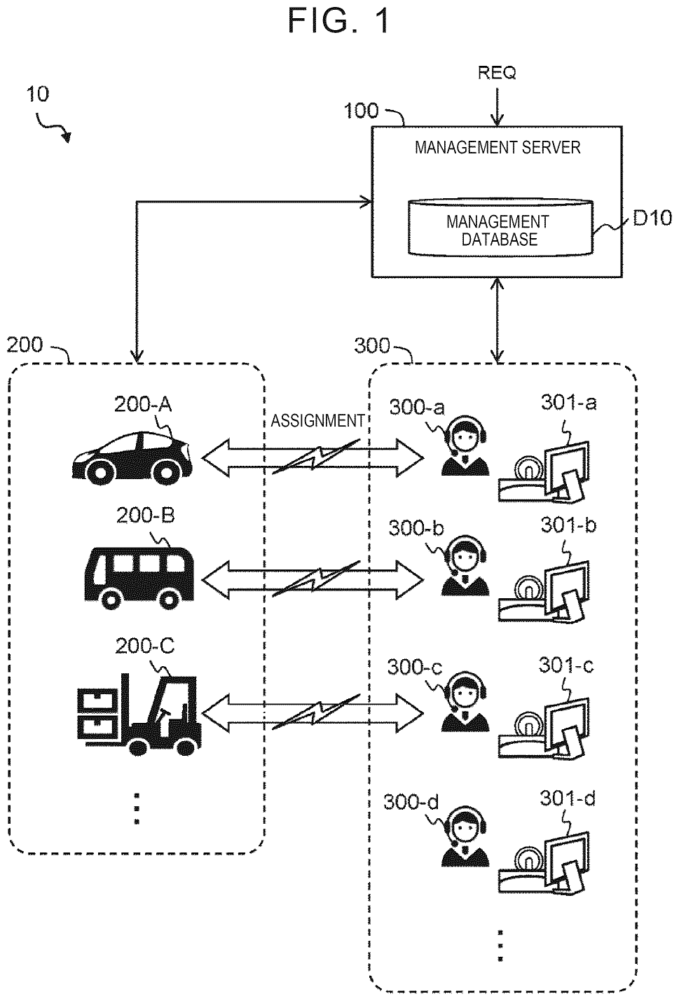

FIG. 1 is a conceptual diagram for describing an overall configuration of a remote driving system 10 according to the present embodiment. The remote driving system 10 includes a management server 100, mobility 200, and a remote driver 300. In the remote driving system 10, the remote driving of the mobility 200 is performed by the remote driver 300.

The mobility 200 is a device capable of performing at least a moving operation. Mobility 200 typically includes a plurality of mobility 200 (200-A, 200-B, 200-C, . . . ). Each mobility 200 may be a different type of mobility. Further, each mobility 200 may be mobility capable of various operations other than the moving operation. For example, the mobility 200 is a vehicle (e.g., a passenger car, a truck, a bus, a MaaS vehicle, an autonomous vehicle, etc.) traveling on a public road. As another example, mobility 200 may be a vehicle (e.g., forklift, factory cart, etc.) used in a factory. As yet another example, mobility 200 may be a special small vehicle (e.g., golf course cart, personal mobility, electrified vehicle chair, etc.). As yet another example, mobility 200 may be a robot (e.g., a logistics robot, a work robot, etc.). As yet another example, mobility 200 may be a flying object (e.g., a drone, etc.). As yet another example, mobility 200 may be a vessel (e.g., a small vessel, a large cruiser, etc.). As yet another example, mobility 200 may be a vehicle (e.g., cart, attraction, etc.) in an amusement park.

The remote driver 300 typically includes a plurality of remote drivers 300 (300-a , 300-b, 300-c, 300-d, . . . ). Remote drivers 300 use remote cockpits 301 (301-a, 301-b, 301-c, 301-d, . . . ) to remotely drive mobility 200. Each remote cockpit 301 is configured to receive various operational inputs associated with remote driving of the mobility 200. That is, each of the remote drivers 300 performs remote driving of the mobility 200 by operating the remote cockpit 301.

The plurality of remote drivers 300 typically reside in a specific facility (mobility service center) and engage in remote driving of the mobility 200. In this case, each remote driver 300 is envisioned to use a remote cockpit 301 deployed within the mobility service center. At this time, the combinations of the remote drivers 300 and the remote cockpits 301 may be predetermined or may be freely changeable. The plurality of remote drivers 300 may include remote drivers 300 that engage in remote driving of mobility 200 outside of the mobility service center. In this case, it is assumed that the remote drivers 300 use remote cockpits 301 that they manage.

The management server 100 is communicably connected to each mobility 200 and each remote cockpit 301 via a communication network. The management server 100 may include a plurality of servers that perform distributed processing.

The management server 100 manages the remote driving system 10. In particular, the management server 100 executes a process of assigning the remote driver 300 to the mobility 200 in response to a request REQ for remote driving of the mobility 200. The request REQ requires servicing support by remote driving of mobility 200. For example, the request REQ may require a sharing car delivery service to deliver the sharing car by remote driving. Also, for example, the request REQ may require passenger transportation services by remote driving of the busses. Also, for example, the request REQ may require supporting stacked autonomous vehicles. In addition, for example, the request REQ requests a package collection and delivery service by remote driving of the forklift. The request REQ includes mobility 200 information and service-support information for which remote driving is required. The request REQ is transmitted from, for example, an operator providing service/support using mobility 200. Alternatively, the request REQ may be sent from the mobility 200 to the management server 100.

The management server 100 stores management database D10. The management database D10 contains data that manages the status of the remote drivers 300. For example, the management database D10 manages data such as the correspondence status and free status of each remote driver 300, management information (e.g., management number, type, terminal specifications, etc.) of the remote cockpit 301 used by each remote driver 300, and ID and attribution information (e.g., age, sex, qualification, background, etc.) of each remote driver. The management database D10 may include data for managing the process status of the respective request REQ received by the management server 100. For example, in the management database D10, data such as mobility 200 corresponding to each request REQ, service/support requested in each request REQ, and remote driver 300 assigned to the corresponding mobility 200 are managed.

Upon receiving the request REQ, the management server 100 checks the mobility 200 and the service-support content for which remote driving is requested. Next, the management server 100 refers to the management database D10 and selects the remote driver 300 to be assigned to the mobility 200 related to the request REQ. When the allocation is performed, communication between the mobility 200 related to the request REQ and the remote cockpit 301 of the allocated remote driver 300 is started based on the data transmitted from the management server 100. Through this communication, remote driving of the mobility 200 by the remote driver 300 is performed. The communication may be performed by relaying the management server 100.

In this way, in the remote driving system 10, the remote driver 300 is assigned to the mobility 200, and the remote driving of the mobility 200 is performed by the assigned remote driver 300. 15

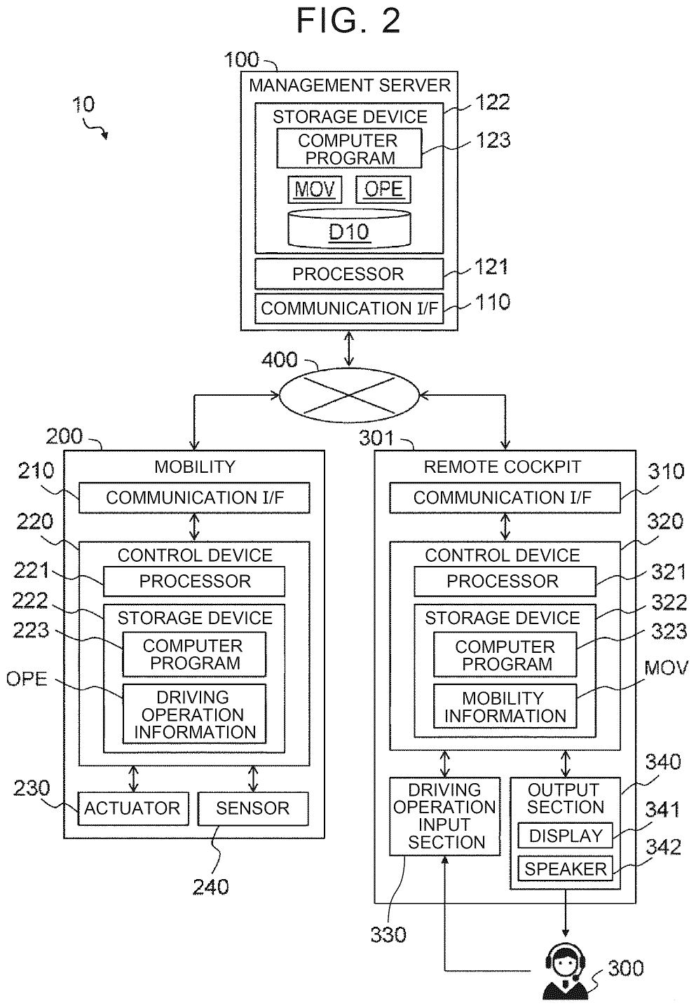

FIG. 2 is a block diagram illustrating a configuration example of the remote driving system 10 related to remote driving of the mobility 200 by the remote driver 300.

The management server 100, the mobility 200, and the remote cockpit 301 are configured to be able to communicate with each other via the communication network 400. The communication network 400 includes, for example, a mobile communication network, the Internet, a LAN, and the like.

The remote cockpit 301 includes a communication interface (communication I/F) 310, a control device 320, a driving operation input unit 330, and an output unit 340.

The communication interface 310 is an interface for connecting to the communication network 400 and communicating with a device external to the remote cockpit 301. The remote cockpit 301 transmits and receives information to and from the management server 100 and the mobility 200 via the communication interface 310.

The control device 320 is a computer that controls the remote cockpit 301. The control device 320 includes a processor 321 and a storage device 322. The processor 321 executes various processes. The processor 321 includes, for example, a general-purpose processor, an application-specific processor, a central processing unit (CPU), a graphics processing unit (GPU), an application specific integrated circuit (ASIC), a field-programmable gate array (FPGA), an integrated circuit, a conventional circuit, and a combination thereof. The processor 321 may also be referred to as a circuitry or a processing circuitry. Circuitry is hardware programmed to implement the functions described herein, or hardware that performs the functions. The storage device 322 stores various kinds of information necessary for execution of processing by the processor 321. The storage device 322 is constituted by a recording medium such as random access memory (RAM), read only memory (ROM), solid state drive (SSD), hard disk drive (HDD), and the like.

The storage device 322 stores a computer program 323. The computer program 323 may be recorded in a computer-readable recording medium. The computer program 323 describes processing to be executed by the processor 321. The function of the control device 320 is realized by the cooperation of the processor 321 executing the computer program 323 and the storage device 322.

In addition, the storage device 322 stores mobility information MOV related to the mobility 200 that is a target of remote driving. The mobility information MOV includes at least operational status information related to the operation of the mobility 200. The operation status information includes, for example, information related to an operation status of the mobility 200, such as a moving speed of the mobility 200, a longitudinal acceleration, a lateral acceleration, an altitude, and an operation status of various mounted devices. Further, the operation status information includes, for example, information on an operating environment of the mobility 200, such as a distance to the surrounding object, a type of the surrounding object, an operation limit imposed in the operation position (for example, speed limit, pause, traveling position, and the like), and the like. In addition, the mobility information MOV includes various kinds of information required for remote driving of the mobility 200 by the remote driver 300. For example, the mobility information MOV includes a video around the mobility 200 and a sound around the mobility. The control device 320 receives the mobility information MOV from the mobility 200.

The output unit 340 is controlled by the control device 320 and outputs information to the remote driver 300. The output unit 340 includes a display 341 and a speaker 342. Based on the mobility information MOV, the control device 320 outputs various kinds of information required for remote driving of the mobility 200 by the remote driver 300 from the output unit 340. For example, the control device 320 displays an image around the mobility 200 on the display 341.

The driving operation input unit 330 receives an input of a driving operation by the remote driver 300. The driving operation input unit 330 includes, for example, an accelerator pedal, a brake pedal, a steering wheel, a joystick, and the like. It is assumed that the remote driver 300 performs a driving operation via the driving operation input unit 330 while recognizing the information output from the output unit 340. The control device 320 acquires the driving operation information OPE input to the driving operation input unit 330, and transmits the acquired driving operation information OPE to the management server 100 and the mobility 200.

The mobility 200 includes a communication interface (communication I/F) 210, a control device 220, an actuator 230, and a sensor 240.

The communication interface 210 is an interface for connecting to the communication network 400 and communicating with a device external to the mobility 200. The mobility 200 transmits and receives information to and from the management server 100 and the remote cockpit 301 via the communication interface 210.

The control device 220 is a computer that controls the mobility 200. The control device 220 includes a processor 221 and a storage device 222. The processor 221 executes various processes. The processor 221 includes, for example, a general-purpose processor, an application-specific processor, a central processing unit (CPU), a graphics processing unit (GPU), an application specific integrated circuit (ASIC), a field-programmable gate array (FPGA), an integrated circuit, a conventional circuit, and a combination thereof. The storage device 222 stores various kinds of information necessary for execution of processing by the processor 221. The storage device 222 is constituted by a recording medium such as random access memory (RAM), read only memory (ROM), solid state drive (SSD), hard disk drive (HDD), and the like.

The storage device 222 stores a computer program 223. The computer program 223 may be recorded in a computer-readable recording medium. The computer program 223 describes processing to be executed by the processor 221. The function of the control device 220 is realized by the cooperation of the processor 221 executing the computer program 223 and the storage device 222.

In addition, the storage device 222 stores driving operation information OPE. The control device 220 receives the driving operation information OPE from the remote cockpit 301. The control device 220 generates a control signal for controlling the actuator 230 based on the driving operation information OPE.

The actuator 230 operates various devices mounted on the mobility 200. For example, the actuator 230 includes an actuator that operates a movement mechanism of the mobility 200. The actuator 230 is driven in accordance with a control signal acquired from the control device 220. The operation of the mobility 200 is realized by driving the actuator 230. In this way, the mobility 200 operates in accordance with the driving operation information OPE.

The sensor 240 detects a mobility information MOV. Examples of the sensor 240 include a velocity sensor, an acceleration sensor, a gyro sensor, and an inertial measurement unit (IMU), a camera, a radar, and a LiDAR, a global navigation satellite system (GNSS) sensor. The control device 220 acquires the mobility information MOV detected by the sensor 240, and transmits the acquired mobility information MOV to the management server 100 and the remote cockpit 301.

The management server 100 includes a communication interface (communication I/F) 110, a processor 121, and a storage device 122.

The communication interface 110 is an interface for connecting to the communication network 400 and communicating with a device external to the management server 100. The management server 100 transmits and receives information to and from the mobility 200 and the remote cockpit 301 via the communication interface 110.

The processor 121 executes various processes. The processor 121 includes, for example, a general-purpose processor, an application-specific processor, a central processing unit (CPU), a graphics processing unit (GPU), an application specific integrated circuit (ASIC), a field-programmable gate array (FPGA), an integrated circuit, a conventional circuit, and a combination thereof. The storage device 122 stores various kinds of information necessary for execution of processing by the processor 121. The storage device 122 is constituted by a recording medium such as random access memory (RAM), read only memory (ROM), solid state drive (SSD), hard disk drive (HDD), and the like.

The storage device 122 stores a computer program 123. The computer program 123 may be recorded in a computer-readable recording medium. The computer program 123 describes processing to be executed by the processor 121. The functions of the management server 100 are realized by the cooperation of the processor 121 executing the computer program 123 and the storage device 122.

In addition, the storage device 122 stores mobility information MOV and driving operation information OPE. The management server 100 acquires the mobility information MOV and the driving operation information OPE from the mobility 200 and the remote cockpit 301, respectively. The storage device 122 also stores a management database D10. The management database D10 may be updated at any time by a process executed by the processor 121.

As described above, the remote driving system 10 according to the present embodiment is configured. The remote driving system 10 according to the present embodiment further has a characteristic function related to remote driving based on the above-d escribed configuration. Features of the remote driving system according to the present embodiment will be described below.

### 2 Features of the Present Embodiment

### 2.1 Assigning Additional Remote Drivers

The management server 100 according to the present embodiment further additionally allocates the remote driver 300 to the mobility 200 to which the remote driver 300 is allocated under a predetermined condition. That is, when a predetermined condition is satisfied, two remote drivers 300 are assigned to one mobility 200. For example, as shown in FIG. 1, a remote driver 300-d is additionally assigned to the mobility 200-A to which the remote driver 300-a is assigned. Hereinafter, the assigned remote driver 300 is referred to as a “first remote driver 300-1”, and the additionally assigned remote driver 300 is referred to as a “second remote driver 300-2”.

The predetermined condition for allocating the second remote driver 300-2 may be appropriately set according to the environment to which the present embodiment is applied. In the remote driving system 10 according to the present embodiment, as will be described later, the second remote driver 300-2 can intervene in the driving operation so as to assist the remote driving by the first remote driver 300-1. That is, assigning the second remote driver 300-2 ensures the safety of remote driving of the mobility 200. On the other hand, assigning the second remote driver 300-2 to all mobility 200 is undesirable from the perspective of the resources of the remote driver 300. In particular, the predetermined condition may be that it is determined that the remote driving by the first remote driver 300-1 is not appropriate.

The determination as to whether or not the remote driving by the first remote driver 300-1 is appropriate can be made based on the comparison between the driving operation information OPE of the remote driving by the first remote driver 300-1 and the operation status information of the mobility 200. For example, in the following cases (1) to (3), it is determined that remote driving by the first remote driver 300-1 is not appropriate.
(1) In the case where a driving operation related to a specific operation such as rapid acceleration, sudden braking, sudden turning, or the like is performed a predetermined number of times or more;
(2) If the driving is continued with insufficient distances from surrounding objects (e.g., other vehicles); and
(3) When a driving operation is performed which does not comply with the operation restrictions imposed at the operating position.

By providing the predetermined condition as described above, it is possible to appropriately allocate the second remote driver 300-2 in view of the resources of the remote driver 300.

### 2.2 Remote Driving by Cooperation of First Remote Driver and Second Remote Driver

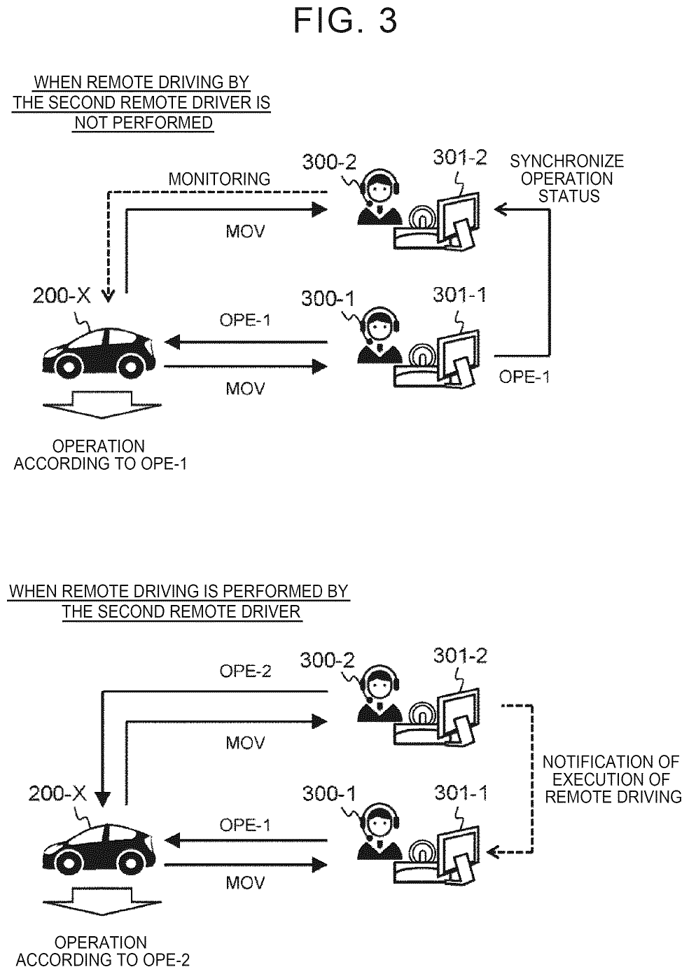

As described above, in the remote driving system 10 according to the present embodiment, two remote drivers 300 of the first remote driver 300-1 and the second remote driver 300-2 are assigned to one mobility 200 (target mobility 200-X) under predetermined conditions. At this time, the remote driving system 10 according to the present embodiment enables the first remote driver 300-1 and the second remote driver 300-2 to perform remote driving of the target mobility 200-X in cooperation with each other. Hereinafter, referring to FIG. 3, remote driving of the target mobility 200-X by the cooperation of the first remote driver 300-1 and the second remote driver 300-2 realized by the remote driving system 10 will be described.

When the second remote driver 300-2 is assigned to the target mobility 200-X, the remote cockpit 301 (the first remote cockpit 301-1) used by the first remote driver 300-1 communicates with the target mobility 200-X. In addition, the remote cockpit 301 (the second remote cockpit 301-2) used by the second remote driver 300-2 also communicates with the target mobility 200-X. That is, the second remote driver 300-2 is ready to operate the second remote cockpit 301-2 to perform remote driving. Therefore, the remote driving of the target mobility 200-X is divided into a time when the remote driving by the second remote driver 300-2 is not performed and a time when the remote driving is performed.

When the remote driving by the second remote driver 300-2 is not performed, only the driving operation information OPE (the first driving operation information OPE-1) of the remote driving by the first remote driver is transmitted to the target mobility 200-X. The target mobility 200-X operates in accordance with the first driving operation information OPE-1. That is, the remote driving by the first remote driver 300-1 is continuously performed. On the other hand, the second remote driver 300-2 may monitor the operation of the target mobility 200-X from the data output from the output unit 340 of the second remote cockpit 301-2.

When the remote driving by the second remote driver 300-2 is not performed, the first driving operation information OPE-1 is transmitted to the second remote cockpit 301-2. Then, the control device 320 of the second remote cockpit 301-2 synchronizes the operation state of the second remote cockpit 301-2 with the operation state of the first remote cockpit 301-1. The operation state to be synchronized is typically an operation amount of the driving operation input unit 330. Examples thereof include the amount of depression of the accelerator pedal, the steering angle of the steering wheel, and the like. The driving operation input unit 330 may include an actuator that can be controlled by the control device 320. The control device 320 can control the operation amount of each member of the driving operation input unit 330 through the control of the actuator. In this way, synchronization of the operating states of the first remote cockpit 301-1 and the second remote cockpit 301-2 is achieved.

It is assumed that the second remote driver 300-2 operates the second remote cockpit 301-2 to intervene in the driving operation when an abnormality is felt in the driving operation of the first remote driver 300-1. By synchronizing the operation states, the second remote driver 300-2 can easily determine the intervention of the driving operation.

Next, a case where remote driving by the second remote driver 300-2 is performed will be described. When the remote driving by the second remote driver 300-2 is being performed, the first driving operation information OPE-1 is transmitted to the target mobility 200-X. In addition, driving operation information OPE (second driving operation information OPE-2) of the remote driving by the second remote driver 300-2 is also transmitted. At this time, in the remote driving system 10 according to the present embodiment, the target mobility 200-X is configured to operate in accordance with the second driving operation information OPE-2. That is, the remote driving of the target mobility 200-X is switched to the remote driving by the second remote driver 300-2. The control device 220 of the target mobility 200-X controls the actuator 230 based on the second driving operation information OPE-2.

When remote driving by the second remote driver 300-2 is being performed, the first remote driver 300-1 is notified that remote driving by the second remote driver 300-2 is being performed. For example, the management server 100 transmits, to the first remote cockpit 301-1, a determination result as to whether or not the remote driving by the second remote driver 300-2 is being performed. Then, when the determination result indicates that the remote driving by the second remote driver 300-2 is being performed, the control device 320 of the first remote cockpit 301-1 notifies the first remote driver 300-1 of the determination result by a display or a sound from the output unit 340. By performing the notification in this way, it is possible to suppress the first remote driver 300-1 from feeling anxiety about the fact that its driving operation is not reflected in the operation of the mobility 200.

As described above, according to the remote driving system 10 of the present embodiment, when remote driving is performed by the second remote driver 300-2, the target mobility 200-X operates in accordance with the second driving operation information OPE-2. That is, remote driving by the second remote driver 300-2 is prioritized. Accordingly, the second remote driver 300-2 can intervene in the driving operation so as to assist the remote driving by the first remote driver 300-1. In this way, the remote driving system 10 according to the present embodiment realizes remote driving of the target mobility 200-X by the cooperation of the first remote driver 300-1 and the second remote driver 300-2. As a consequence, it is possible to appropriately secure the safety of remote driving of the target mobility 200-X.

### 2.3 Switching Period

As described above, when remote driving by the second remote driver 300-2 is started, remote driving of the target mobility 200-X is switched to remote driving by the second remote driver 300-2. That is, the target mobility 200-X switches from the operation according to the first driving operation information OPE-1 to the operation according to the second driving operation information OPE-2. At this time, there is a possibility that the operation of the target mobility 200-X suddenly changes due to differences between the first driving operation information OPE-1 and the second driving operation information OPE-2.

Therefore, the remote driving system 10 according to the present embodiment may be configured such that, when the remote driving by the second remote driver 300-2 is started, the target mobility 200-X has a switching duration. The switching period is a period from the operation according to the first driving operation information OPE-1 to the operation according to the second driving operation information OPE-2. The target mobility 200-X may be configured to operate in accordance with the third driving operation information OPE-3 gradually changing from the first driving operation information OPE-1 to the second driving operation information OPE-2 during the switching period.

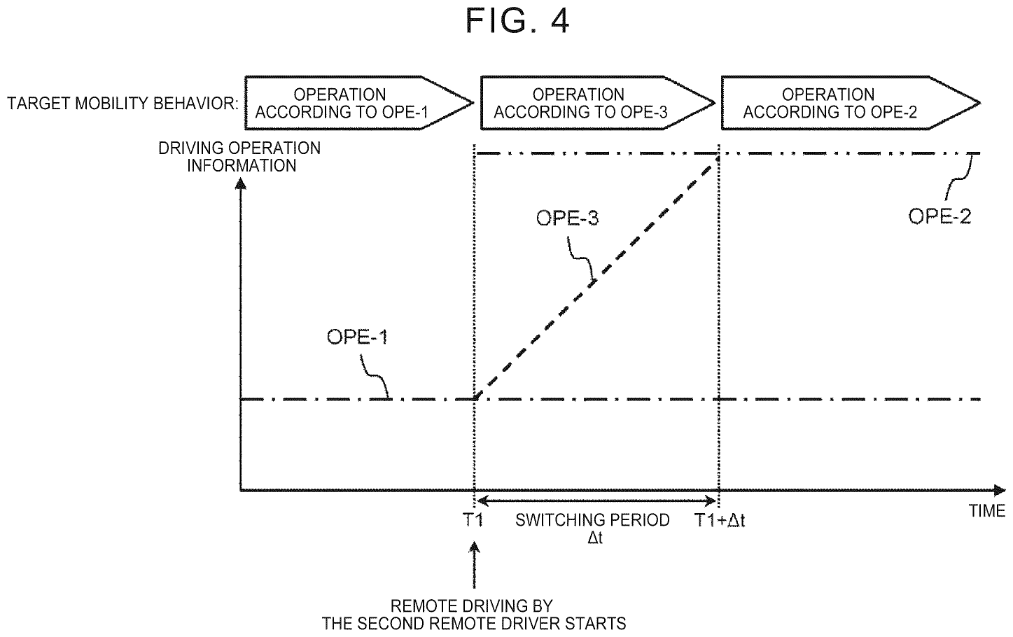

FIG. 4 is a conceptual diagram for explaining a switching period. FIG. 4 conceptually illustrates time-series data of the first driving operation information OPE-1 and the second driving operation information OPE-2. In particular, the remote driving by the second remote driver 300-2 is started at the time T1. As illustrated in FIG. 4, the third driving operation information OPE-3 is generated so as to gradually change from the first driving operation information OPE-1 to the second driving operation information OPE-2 during the switching period Δt. The target mobility 200-X operates according to the first driving operation information OPE-1 until the time T1. In addition, the target mobility 200-X operates in accordance with the third driving operation information OPE-3 during a period from the time T1 to the switching period Δt. The target mobility 200-X operates according to the second driving operation information OPE-2 from the time T1+Δt.

For example, the control device 220 of the target mobility 200-X generates the third driving operation information OPE-3 by changing α a to 0→1 during the switching period Δt according to the following Expression (1). Then, the control device 220 of the target mobility 200-X controls the actuator 230 based on the third driving operation information OPE-3 during the switching period Δt.

$$( OPE - 3 ) = ( OPE - 2 ) \times α + ( OPE - 1 ) \times ( 1 - α ) \qquad Expression ( 1 )$$

As described above, since the remote driving system 10 has the switching period, it is possible to suppress the operation of the target mobility 200-X from suddenly changing when the remote driving by the second remote driver 300-2 is started. As a consequence, the remote driving of the target mobility 200-X can be more secure.

### 2.4 Processing Flow

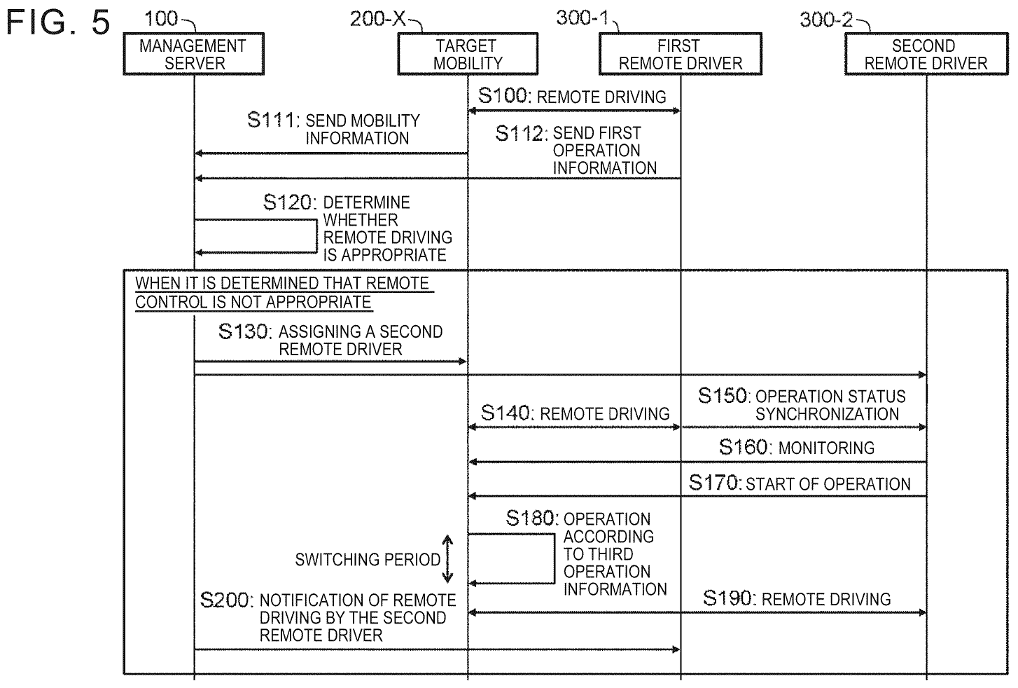

FIG. 5 is a diagram illustrating a processing flow executed in the remote driving system 10 according to the present embodiment. In FIG. 5, some processing by the first remote driver 300-1 and the second remote driver 300-2 is replaced with processing by the first remote cockpit 301-1 and the second remote cockpit 301-2, respectively, as described below.

First, the first remote driver 300-1 is assigned to the target mobility 200-X. The first remote driver 300-1 performs remote driving of the target mobility 200-X (S100). At this time, the target mobility 200-X operates in accordance with the first driving operation information OPE-1.

While the remote driving by the first remote driver 300-1 is being performed, the target mobility 200-X transmits a mobility information MOV including the operation status information of the target mobility 200-X to the management server 100 (S111). In addition, the first remote cockpit 301-1 transmits the first driving operation information OPE-1 to the management server 100 (S112).

The management server 100 determines whether the remote driving by the first remote driver 300-1 is appropriate based on comparing the first driving operation information OPE-1 with the operation status information of the target mobility 200-X (S120). When it is determined that the remote driving by the first remote driver 300-1 is appropriate, the remote driving (S100) by the first remote driver 300-1 is continued.

When it is determined that the remote driving by the first remote driver 300-1 is not appropriate, the management server 100 allocates the second remote driver 300-2 to the target mobility 200-X (S130).

After the allocation of the second remote driver 300-2 is performed, when the remote driving by the first remote driver 300-1 is performed (S140), the operating state of the second remote cockpit 301-2 is synchronized with the operating state of the first remote cockpit 301-1 (S150). The second remote driver 300-2 confirms the driving operation of the first remote driver 300-1 from the synchronized operating state. Further, the second remote driver 300-2 monitors the operation of the target mobility 200-X from the data of the output unit 340 of the second remote cockpit 301-2 (S160).

The second remote driver 300-2 starts the driving operation via the second remote cockpit 301-2 when an abnormality is felt in the driving operation of the first remote driver 300-1 or the like (S170).

When the second remote driver 300-2 starts the driving operation, the target mobility 200-X operates according to the third driving operation information OPE-3 during the switching S180. The third driving operation information OPE-3 is generated so as to gradually change from the first driving operation information OPE-1 to the second driving operation information OPE-2 during the switching time.

After the switching period, the target mobility 200-X is remotely driven by the second remote driver 300-2 (S190). At this time, the target mobility 200-X operates in accordance with the second driving operation information OPE-2. In addition, the management server 100 notifies the first remote driver 300-1 that the remote driving by the second remote driver 300-2 is being performed.

What is claimed is:

1. A remote driving system in which a remote driver is assigned to a mobility and remote driving of the mobility is performed by the assigned remote driver, the remote driving system comprising one or more processors configured to additionally assign, under a predetermined condition, a second remote driver to a target mobility to which a first remote driver is assigned, wherein the target mobility is configured to operate based on first driving operation information on the remote driving by the first remote driver while the remote driving by the second remote driver is not being performed, and to operate based on second driving operation information on the remote driving by the second remote driver while the remote driving by the second remote driver is being performed.

2. The remote driving system according to claim 1, wherein the one or more processors are configured to:
acquire the first driving operation information and operation status information on operation of the target mobility;
determine, based on comparison of the first driving operation information and the operation status information, whether the remote driving by the first remote driver is appropriate; and
additionally assign the second remote driver to the target mobility under a condition that determination is made that the remote driving by the first remote driver is not appropriate.

3. The remote driving system according to claim 1, wherein:
the first remote driver performs the remote driving by operating a first remote cockpit;
the second remote driver performs the remote driving by operating a second remote cockpit; and
the one or more processors are further configured to, while the remote driving by the second remote driver is not being performed, synchronize an operation state of the second remote cockpit with an operation state of the first remote cockpit based on the first driving operation information.

4. The remote driving system according to claim 1, wherein:
when the remote driving by the second remote driver is started, the target mobility has a switching period of switching from operation based on the first driving operation information to operation based on the second driving operation information; and
the target mobility is configured to operate based on third driving operation information generated to gradually change from the first driving operation information to the second driving operation information during the switching period.

5. The remote driving system according to claim 1, wherein the one or more processors are further configured to, while the remote driving by the second remote driver is being performed, notify the second remote driver that the remote driving by the second remote driver is being performed.
